(19) United States
(12) Patent Application Publication
(10) Pub. No.: US 2011/0134226 A1
(43) Pub. Date: Jun. 9, 2011

(54) 3D IMAGE DISPLAY APPARATUS AND METHOD FOR DETERMINING 3D IMAGE THEREOF

(75) Inventor: Ji-won KIM, Seoul (KR)

(73) Assignee: SAMSUNG ELECTRONICS CO., LTD., Suwon-si (KR)

(21) Appl. No.: 12/938,802

(22) Filed: Nov. 3, 2010

(30) Foreign Application Priority Data
Dec. 4, 2009 (KR) 10-2009-0119917

(51) Int. Cl. H04N 13/02

(52) U.S. Cl. 348/51; 348/E13.075

(57) ABSTRACT

A three dimensional (3D) display apparatus and a method for determining a 3D image are provided. The 3D display apparatus detects definition information of a received image data, and determines whether the received image data is 3D image data based on the detected definition information. Therefore, the 3D display apparatus may determine whether or not that a received image is a 3D image.

### CROSS-REFERENCE TO RELATED APPLICATIONS

This application claims priority under 35 U.S.C. §119 from Korean Patent Application No. 10-2009-0119917, filed on Dec. 4, 2009, in the Korean Intellectual Property Office, the disclosure of which is incorporated herein by reference in its entirety.

### BACKGROUND

1. Field

Apparatuses and methods consistent with the exemplary embodiments relate to a three dimensional (3D) display apparatus and a method for detecting a 3D image thereof, and more particularly, to a 3D display apparatus which implements a 3D image by displaying a left eye image and a right eye image in turn on a screen and a method for determining a 3D image thereof.

2. Description of the Related Art

Three dimensional (3D) image display technology is applied in a wide variety of fields, including communications, broadcasting, medical services, education, the military, computer games, computer animation, virtual reality, computer-aided design (CAD), industrial technology, or the like, and is at the core of current development for the next generation of information communication, for which there is currently a highly competitive development environment.

A person perceives a 3D effect due to various reasons, including variations in the thickness of the lenses of his or her eyes, the angle between his or her eyes and the subject, the position of the subject as viewed through both eyes, the parallax caused by the motion of the subject, and psychological effects.

Binocular disparity, which refers to the difference between the images of an object as seen by the left and right eyes due to the horizontal separation of the eyes by about 6 to 7 cm, is the most important factor in producing a three-dimensional effect. The left and right eyes see different two dimensional images which are transmitted to the brain through the retina. The brain then fuses these two different images with great accuracy to reproduce the sense of a three-dimensional image.

There are two types of 3D image display apparatuses: eyeglass type and non-eyeglass type apparatuses. The eyeglass type apparatuses may mainly include in its category: a color filter type apparatus which filters an image using a color filter including complementary color filter segments; a polarizing filter type apparatus which divides an image into a left eye image and a right eye image using a shading effect caused by a polarized light element, the directions of which are orthogonal to each other; and a shutter glass type apparatus which blocks a left eye and right eye alternately to correspond to a synchronization signal.

A 3D image includes a left eye image which a left eye perceives and a right eye image which a right eye perceives. The 3D display apparatus creates a stereoscopic effect, using binocular disparity, which is the difference in image of an object seen by the left and right eyes.

There are various formats for transmitting a left eye image and a right eye image of a 3D image. However, the 3D display apparatus cannot support all of the formats. In addition, it is difficult for a user to distinguish whether an input image is a 3D image or not. If a 3D image is input to a display apparatus while the display apparatus operates in a two dimensional (2D) display mode, the display apparatus fails to display an input image normally and thus a user may think that the display apparatus is out of order.

Therefore, a method is required, in which a 3D display apparatus automatically determines whether an incoming image is a 3D image or not.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

The exemplary embodiments provide a three-dimensional (3D) display apparatus which detects definition information of incoming image data and determines whether the incoming image data is a 3D image data or not based on the detected definition information and a method for determining a 3D image.

According to an exemplary embodiment, there is provided a three-dimensional (3D) display apparatus, including an image receiving unit which receives image data; and a control unit which detects definition information of the received image data, and determines whether the received image data is 3D image data based on the detected definition information.

According to an exemplary embodiment, if a vertical definition of the received image data is higher than the vertical definition of 2D image data having the same horizontal definition of the received image data, the control unit may determine that the received image data is 3D image data.

According to an exemplary embodiment, if the vertical definition of the received image data is higher than the vertical definition of 2D image data having the same horizontal definition of the received image data, the control unit may determine that the received image data is 3D image data according to a frame packing format.

According to an exemplary embodiment, if it is determined that the received image data is 3D image data, the control unit may convert an unsupported format of the 3D image data to a supported 3D format.

The 3D display apparatus may further include a 3D image forming unit which generates a left eye image frame and a right eye image frame corresponding to the 3D image data having the converted format; and a display unit which alternately displays the left eye image frame and the right eye image frame.

The image receiving unit may receive the image data over high definition multimedia interface (HDMI).

The definition information may include H_total and V_total of the HDMI format.

According to another exemplary embodiment, there is provided a method for determining a three-dimensional (3D) image, including receiving image data; detecting definition information of the received image data; and determining whether the received image data is 3D image data based on the detected definition information.

The determining, if a vertical definition of the received image data is higher than the vertical definition of 2D image data having the same horizontal definition of the received image data, may determine that the received image data is 3D image data.

The determining, if the vertical definition of the received image data is higher than the vertical definition of 2D image data having the same horizontal definition of the received image data, may determine that the received image data is 3D image data which has a frame packing format.

The method may further include, if it is determined that the received image data is 3D image data, converting an unsupported format of the 3D image data to a supported 3D format.

The method may further include generating a left eye image frame and a right eye image frame corresponding to the 3D image data having the converted format; and displaying the left eye image frame and the right eye image frame alternately.

The receiving may receive the image data over high definition multimedia interface (HDMI).

The definition information may include H_total and V_total of the HDMI format.

### BRIEF DESCRIPTION OF THE DRAWINGS

The above and/or other aspects of the exemplary embodiment will be more apparent by describing certain exemplary embodiments with reference to the accompanying drawings, in which:

FIG. 1 is a view illustrating a 3D TV and 3D glasses according to an exemplary embodiment;

FIG. 2 is a block diagram illustrating a 3D TV according to an exemplary embodiment;

FIG. 3 is a flowchart provided to explain a method for determining a 3D image according to an exemplary embodiment

FIGS. 4A and 4B are views illustrating 2D image data and 3D image data according to a frame packing format according to an exemplary embodiment; and

FIG. 5 is a table illustrating H_total, V_total, and V_freq of 2D image data and 3D image data for each resolution using a frame packing format according to an exemplary embodiment.

### DETAILED DESCRIPTION OF THE EXEMPLARY EMBODIMENTS

Certain exemplary embodiments will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

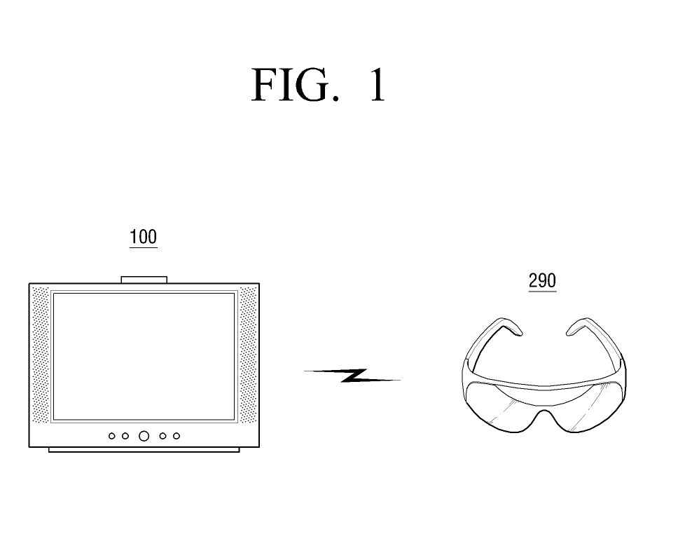

FIG. 1 is a view illustrating a 3D TV 100 and 3D glasses 290 according to an exemplary embodiment. Referring to FIG. 1, the 3D TV 100 is capable of communicating with the 3D glasses 290.

The 3D TV 100 detects definition information of the incoming image data, and determines whether the incoming image data is a 3D image or not based on the detected definition information. If it is determined that the incoming image data is a 3D image, the 3D TV 100 converts a format of the 3D image into another image format which is capable of being displayed. The 3D TV 100 generates a left eye image frame and a right eye image frame corresponding to the 3D image in the converted image format. The 3D TV 100 displays a left eye image frame and a right eye image frame alternately to implement a 3D image.

Herein, the types of the 3D image data may be classified according to a pattern of carrying the left-eye image data and right-eye image data. The 3D image data format includes a top and bottom format, a side-by-side format, a horizontal interleave format, a vertical interleave format, a checkerboard format, a frame sequential format, a field sequential format, a frame packing format, and so on.

The 3D TV 100 generates a left eye image and a right eye image, and displays the left eye image and the right eye image alternatively. A user views the left eye image and the right eye image displayed on the 3D TV 100 with the left and right eyes alternately using the 3D glasses 290 to watch the 3D image.

Specifically, the 3D TV 100 generates a left eye image frame and a right eye image frame, and displays the generated left eye image frame and right eye image frame on a screen at a predetermined time interval in an alternate order. The 3D TV 100 generates a synchronization signal for synchronizing the 3D glasses 290 with the generated left eye image frame and right eye image frame, and transmits the synchronization signal to the 3D glasses 290.

The 3D glasses 290 receive the synchronization signal from the 3D TV 100, and open a left eyeglass and a right eyeglass alternately in sync with the left eye image frame and right eye image frame displayed on the 3D TV 100.

Therefore, a user may view a 3D image using the 3D TV 100 and the 3D glasses 290 shown in FIG. 1. In addition, as the 3D TV 100 automatically recognizes whether a 3D image is input or not, if a 3D image is input, the 3D TV 100 operates in a 3D image mode automatically without a user's manipulation.

If a 3D image is received in an unsupportable format, the 3D TV 100 converts the 3D image format into a supportable format. Therefore, the 3D TV 100 may display a 3D image in various formats.

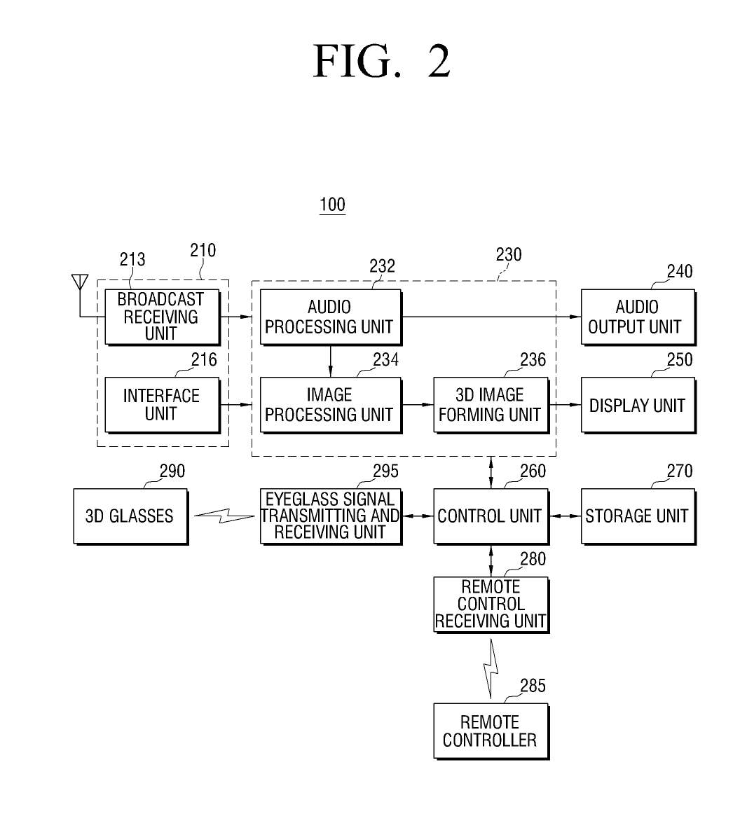

FIG. 2 is a block diagram illustrating the 3D TV 100 according to an exemplary embodiment. Referring to FIG. 2, the 3D TV 100 comprises an image receiving unit 210, an audio/video (A/V) processing unit 230, an audio output unit 240, a display unit 250, a control unit 260, a storage unit 270, a remote control receiving unit 280, and an eyeglass signal transmitting and receiving unit 295.

The image receiving unit 210 receives an image signal or image data from an external source. The image receiving unit 210 also receives 3D image data from an external source. As shown in FIG. 2, the image receiving unit 210 comprises a broadcast receiving unit 213 and an interface unit 216.

The broadcast receiving unit 213 may receive a broadcast in a wired or wireless manner from a broadcast station or a satellite and demodulates the received broadcast. Additionally, the broadcast receiving unit 213 may receive a 3D image signal including 3D image data in addition to 2D image data.

The interface unit 216 is connected to an external apparatus, for example, a digital versatile disc (DVD) player, and receives an image. In particular, the interface unit 216 may receive 3D image data as well as 2D image data from the external apparatus. The interface unit 216 may interface with a S-Video, a component, a composite, a D-Sub, a digital visual interface (DVI), or a high definition multimedia interface (HDMI).

The term ‘3D image data’ refers to data that carries 3D image information. Specifically, the 3D image data carries left-eye image data and right-eye image data in one data frame. The types of the 3D image data may be classified according to a pattern of carrying the left-eye image data and right-eye image data. Specifically, the types of the 3D image data include a top-bottom format, a side-by-side format, a horizontal interleave format, a vertical interleave format, a checkerboard format, a frame sequential format, a field sequential format, a frame packing format, and so on.

In HDMI 1.4, 3D image data is bound to be input in a frame packing format among the 3D image data formats. Therefore, when 3D image data is received over HDMI 1.4, the 3D image data is in a frame packing format.

In this exemplary embodiment, it is assumed that the 3D TV 100 does not support 3D image data according to the frame packing format.

The A/V processing unit 230 implements signal processing such as video-decoding, video-scaling, or audio-decoding on an image signal and an audio signal input from the image receiving unit 210, and generates and adds an on-screen display (OSD).

Meanwhile, to store the input image and audio signals in the storage unit 270, the A/V processing unit 230 may compress the input signals so that the signals are stored in the compressed form.

As illustrated in FIG. 2, the A/V processing unit 230 comprises an audio processing unit 232, an image processing unit 234, and a 3D image forming unit 236.

The audio processing unit 232 carries out processing such as audio-decoding for the input audio signal. The audio processing unit 232 then outputs the resultant audio signal to the audio output unit 240.

The image processing unit 234 carries out processing such as video-decoding or video-scaling with respect to the input image signal. If it is determined that the input image data is 3D image data, the image processing unit 234 converts the 3D image data format. To be specific, if it is determined that image data being received over HDMI 1.4 is 3D image data, the received image data may be 3D image data according to the frame packing format. However, the general 3D TV 100 may not support the 3D image data in the frame packing format since two frame data are input at the same time. Therefore, the image processing unit 234 may convert the frame packing format of the received 3D image data into another format. For instance, the image processing unit 234 may convert the 3D image data from the frame packing format into one of a top and bottom format, a side-by-side format, a horizontal interleave format, a vertical interleave format, a checkerboard format, a frame sequential format, and a field sequential format.

The image processing unit 234 may convert the 3D image data format and then output the converted 3D image data to the 3D image forming unit 236.

As described above, the image processing unit 234 converts the 3D image data in the frame packing format which is not supported by the 3D TV 100 to another format so that the 3D TV 100 may display a 3D image even if 3D image data in the frame packing format is input over HDMI 1.4.

The 3D image forming unit 236 generates a left eye image frame and a right eye image frame which are interpolated to a full screen size by utilizing the converted 3D image data. Accordingly, the 3D image forming unit 236 generates a left eye image frame and a right eye image frame to be displayed on a screen to display a 3D image.

The 3D image forming unit 236 outputs a left eye image frame and a right eye frame to the display unit 250 at the timing of outputting a left eye image and a right eye image, respectively.

The audio output unit 240 outputs the audio signal transmitted from the A/V processor 230 to a speaker, or the like.

The display unit 250 outputs the image transmitted from the A/V processor 230 to be displayed on a screen. Specifically, regarding the 3D image, the display unit 250 alternately outputs the left-eye image frame and the right-eye image frame to the screen.

The storage unit 270 stores programs required to operate the 3D TV 100 or a recorded image file. The storage unit 270 may be implemented as a hard disk drive, or a non-volatile memory.

The remote control receiving unit 280 may receive a user's instruction from a remote controller 285 and transmit the received instruction to the control unit 260.

The eyeglass signal transmitting and receiving unit 295 transmits a clock signal to alternately open a left eyeglass and a right eyeglass of the 3D glasses 290. The 3D glasses 290 alternately open the left eyeglass and the right eyeglass according to the received clock signal. Additionally, the eyeglass signal transmitting and receiving unit 295 receives information such as the current status from the 3D glasses 290.

The control unit 260 analyzes the user's instruction based on the instruction received from the remote controller 285, and controls the overall operation of the 3D TV 100 according to the analyzed instruction.

Specifically, the control unit 260 detects definition information of the received image data, and determines whether the received image data is 3D image data or not based on the detected definition information. If it is determined that the received image data is 3D image data, the control unit 260 controls the 3D TV 100 to operate in a 3D image display mode. Herein, the term ‘3D image display mode’ refers to the mode in which the 3D TV 100 operates when the 3D image is input. If the 3D TV 100 is set in the 3D image display mode, the 3D image forming unit 236 is activated.

Herein, the definition information means horizontal and vertical definition of image data included in a single period. According to the HDMI standard, the horizontal definition of image data corresponds to the total number of pixels in a horizontal scanning line (H_total), and the vertical definition of image data corresponds to vertical scanning line (V_total). The definition information of image data is included in the header information of the image data. Therefore, the control unit 260 may detect the definition information from the header information of the image data.

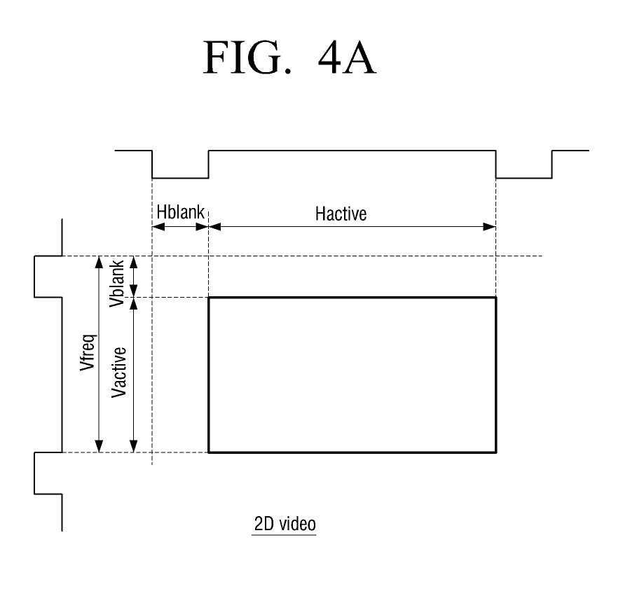

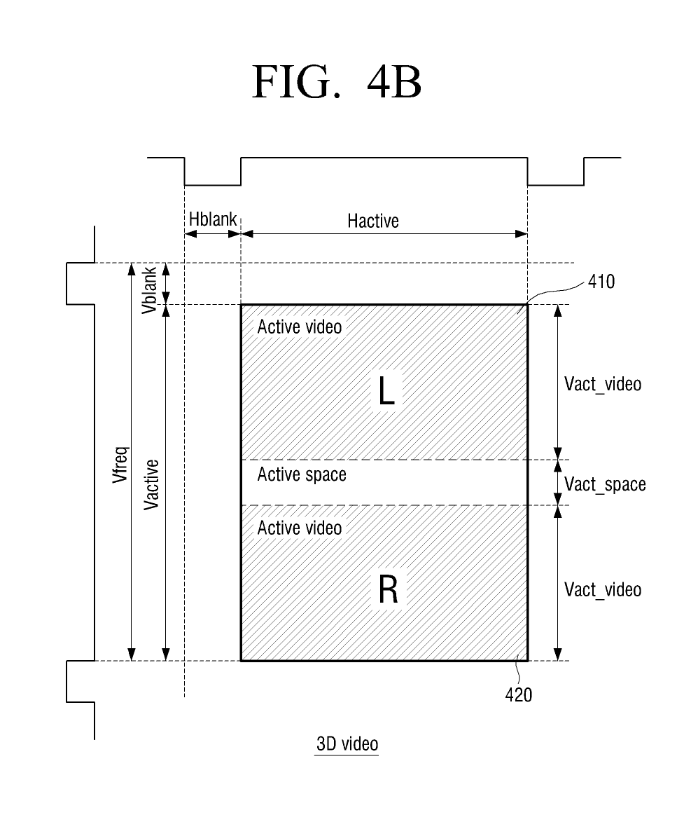

In HDMI 1.4, 3D image data is input in a frame packing format. The frame packing format refers to a format in which left image data and right image data are integrated in one active period in a vertical direction and then transmitted. The structure of the frame packing format is illustrated in FIG. 4B, and this will be explained later. The 3D image data according to the frame packing format has a vertical definition (V_total) higher than that of 2D image data. By way of example, 2D image data at a definition of 1920*1080p may have a horizontal definition (H_total) of 2750 and a vertical definition (V_total) of 1125. Meanwhile, 3D image data at a definition of 1920*1080p according to the frame packing format may have H_total of 2750 and V_total of 2250. Accordingly, the 3D image data according to the frame packing format has V_total higher than that of the 2D image data.

Accordingly, the control unit 260 detects the V_total of an incoming image, and if the V_total of the incoming image is higher than the V_total of the 2D image having the same H_total as the H_total of the incoming image, the control unit 260 determines that the incoming image is a 3D image according to the frame packing format.

If it is determined that the received image data is 3D image data, the control unit 260 converts the format of the 3D image data. Specifically, if the received image data is 3D image data, the control unit 260 controls the image processing unit 234 to convert the format of the 3D image data into another format which the 3D image forming unit 236 can support. For example, the control unit 260 converts the 3D image data from the frame packing format into another format such as a top and bottom format, a side-by-side format, a horizontal interleave format, a vertical interleave format, a checkerboard format, a frame sequential format, and a field sequential format.

As described above, if the 3D image forming unit 236 does not support the frame packing format, the control unit 260 may convert the received 3D image data into a supportable format.

The 3D TV 100 having the above described structure may determine whether the received image data is a 3D image or not. Even if a 3D image in a format which is not supported by the 3D image forming unit 236 is input, the 3D TV 100 may display the 3D image by converting the 3D image into a supportable format.

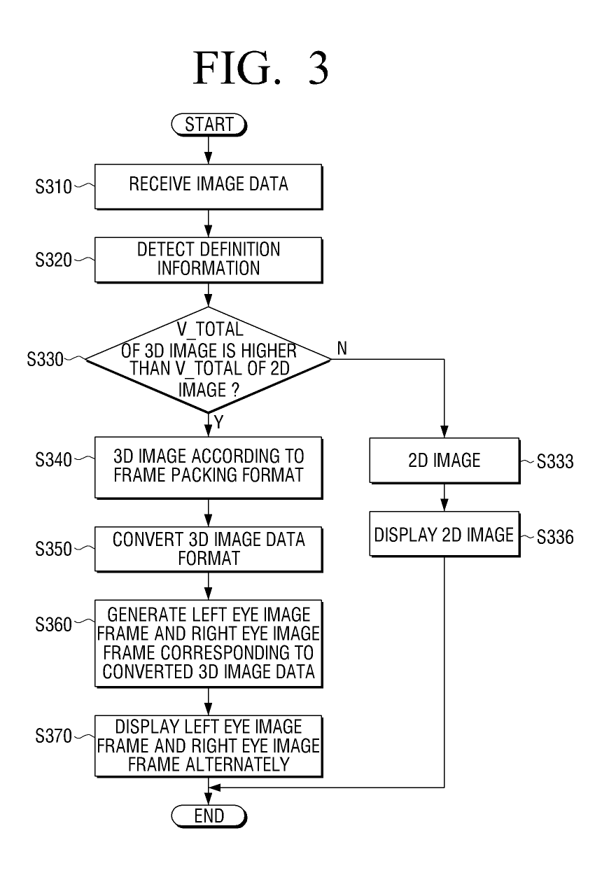

Hereinbelow, a method for determining a 3D image will be explained in detail with reference to FIG. 3. FIG. 3 is a flowchart provided to explain a method for determining a 3D image according to an exemplary embodiment.

The 3D TV 100 receives an image signal or image data from an external source (operation S310). Specifically, the image receiving unit 210 may receive 2D image data or 3D image data from an external source. In this situation, HDMI 1.4 requires that the 3D image support a frame packing format. Accordingly, when 3D image data is received over HDMI 1.4, the 3D image data is in the frame packing format.

In this exemplary embodiment, it is supposed that the 3D TV 100 does not support 3D image data in the frame packing format.

The 3D TV 100 detects information regarding definition of the received image data (operation S320). Herein, the definition information means a horizontal definition and a vertical definition of image data included in a single frequency. According to the HDMI standard, the horizontal definition of image data corresponds to the total number of pixels in a horizontal scanning line (H_total), and the vertical definition of image data corresponds to vertical scanning line (V_total). The definition information of image data is included in header information of the image data. Therefore, the 3D TV 100 may detect the definition information from the information on a header of image data.

The 3D TV 100 determines whether the received image data is 3D image data or not based on the definition information. In more detail, the 3D TV 100 determines whether the V_total of the received image data is higher than that of the 2D image data having the same H_total as that of the received image data (operation S330).

HDMI 1.4 requires that the 3D image support a frame packing format. The frame packing format refers to a format in which left image data and right image data are integrated in one active period in a vertical direction and then transmitted. The structure of the frame packing format is illustrated in FIG. 4B, and this will be explained later. The 3D image data according to the frame packing format has a vertical definition higher than that of 2D image data. For instance, 2D image data at a definition of 1920*1080p may have a horizontal definition (H_total) of 2750 and a vertical definition (V_total) of 1125. Meanwhile, 3D image data at a definition of 1920*1080p according to the frame packing format may have H_total of 2750 and V_total of 2250. Thus, the 3D image data according to the frame packing format has a V_total higher than the V_total of the 2D image data.

Accordingly, the 3D TV 100 detects a vertical definition of an incoming image, and if the V_total of the incoming image is higher than the V_total of the 2D image having the same H_total as the H_total of the incoming image, the 3D TV 100 determines that the incoming image is a 3D image according to the frame packing format.

If the V_total of the incoming image data is equal to or lower than that of the 2D image data having the same H_total as that of the incoming image data (operation S330-N), the 3D TV 100 determines that the incoming image is a 2D image (operation S333). The 3D TV 100 displays the 2D image on a screen (operation S336).

On the other hand, if the V_total of the incoming image data is higher than that of the 2D image data having the same H_total as that of the incoming image data (operation S330-N), the 3D TV 100 determines that the incoming image data is a 3D image (operation S340). The 3D TV 100 operates in a 3D image display mode. Herein, the 3D image display mode refers to a mode in which the 3D TV 100 operates when a 3D image is input. When the 3D TV 100 is set in the 3D image display mode, the 3D image forming unit 236 is activated.

If it is determined that the incoming image data is 3D image data, the 3D TV 100 converts the 3D image data format (operation S350). Specifically, if it is determined that the image being received over HDMI 1.4 is a 3D image, the received image may be the 3D image in the frame packing format. However, since the 3D image data in the frame packing format is input in such a manner that two frame data are input concurrently, the general 3D TV 100 may not support the frame packing format. To this end, the 3D TV 100 converts the received 3D image data from the frame packing format into another format. By way of example, the 3D TV 100 may convert the received 3D image data from the frame packing format into one of a top and bottom format, a side-by-side format, a horizontal interleave format, a vertical interleave format, a checkerboard format, a frame sequential format, and a field sequential format.

As described above, even if the 3D image data according to the frame packing format which is not supported by the 3D TV 100 is input, the 3D TV 100 may display a 3D image over HDMI 1.4 by converting the 3D image data format into a supportable format.

After that, the 3D TV 100 generates a left eye image frame and a right eye image frame which are interpolated to a full screen size by utilizing the converted 3D image data (operation S360). Accordingly, the 3D TV 100 displays alternately the left eye image frame and right eye image frame on a screen (operation S370).

Through the above process, the 3D TV 100 may determine whether the received image data is a 3D image or not. Even if 3D image data that the 3D image forming unit 236 does not support is received, the 3D TV 100 may display a 3D image by converting a 3D image data format into a supportable format.

Hereinbelow, a frame packing format will be explained in detail with reference to FIGS. 4A and 4B. FIGS. 4A and 4B are views illustrating 2D image data and 3D image data in a frame packing format according to an exemplary embodiment.

FIG. 4A is a schematic view of 2D image data, and FIG. 4B is a schematic view of 3D image data according to a frame packing format.

Referring to FIG. 4B, 3D image data according to the frame packing format is constructed in such a manner that a left eye image frame and a right eye image frame are integrated in one active period. Accordingly, the 3D image data according to the frame packing format has V_total higher than that of the 2D image data.

The 3D TV 100 may determine whether or not an incoming image is a 3D image according to the frame packing format by utilizing the H_total and the V_total.

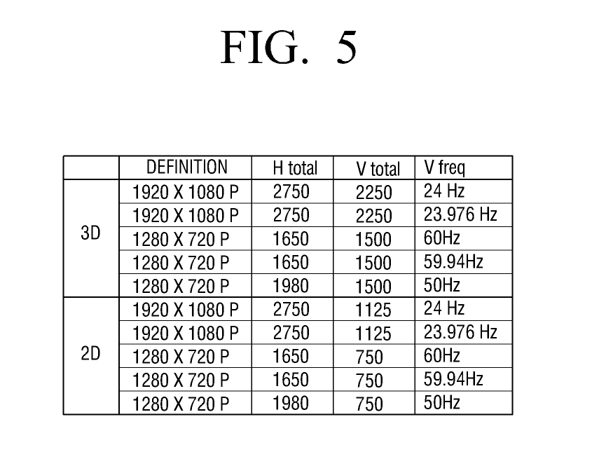

FIG. 5 is a table illustrating H_total, V_total, and V_freq of 2D image data and 3D image data for each resolution using a frame packing format according to an exemplary embodiment.

As shown in FIG. 5, V_total of the 3D image data doubles that of the 2D image data. Therefore, the 3D TV 100 may determine whether the incoming image is a 2D image or a 3D image in the frame packing format by comparing the V_total of the 3D image data with the V_total of the 2D image having the same H_total as that of the 3D image.

Although the 3D TV 100 is exemplified as the 3D display apparatus according to the exemplary embodiments explained above, it should be understood that any apparatus that is capable of displaying a 3D image may be equally applicable. By way of example, the 3D display apparatus may be implemented as a 3D monitor, or a 3D image projector.

As explained above, according to the various exemplary embodiments, a 3D display apparatus which detects information on definition of received image data and determines whether the received image data is 3D image data or not based on the definition information and a method for determining a 3D image are provided. Accordingly, the 3D display apparatus may determine whether an incoming image is a 3D image or not.

In addition, the 3D display apparatus converts the incoming 3D image data format into another format in which the 3D image can be displayed. Therefore, the 3D display apparatus may display a 3D image in various formats.

The foregoing exemplary embodiments are merely exemplary and are not to be construed as limiting. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A three-dimensional (3D) display apparatus, comprising:
an image receiving unit which receives image data; and
a control unit which detects definition information of the received image data, and determines whether the received image data is 3D image data based on the detected definition information.

2. The 3D display apparatus as claimed in claim 1, wherein when a vertical definition of the received image data is higher than a vertical definition of two dimensional (2D) image data which has same horizontal definition of the received image data, the control unit determines that the received image data is 3D image data.

3. The 3D display apparatus as claimed in claim 2, wherein when the vertical definition of the received image data is higher than the vertical definition of the 2D image data which has the same horizontal definition of the received image data, the control unit determines that the received image data is 3D image data which has to a frame packing format.

4. The 3D display apparatus as claimed in claim 1, wherein when it is determined that the received image data is 3D image data, the control unit converts an unsupported format of the 3D image data to a supported 3D format.

5. The 3D display apparatus as claimed in claim 4, further comprising:
a 3D image forming unit which generates a left eye image frame and a right eye image frame which corresponds to the 3D image data which has the converted format; and
a display unit which alternately displays the left eye image frame and the right eye image frame.

6. The 3D display apparatus as claimed in claim 1, wherein the image receiving unit receives the image data over a high definition multimedia interface (HDMI).

7. The 3D display apparatus as claimed in claim 6, wherein the definition information includes H_total and V_total of an HDMI format.

8. A method for determining a three-dimensional (3D) image, the method comprising:
receiving image data;
detecting definition information of the received image data; and
determining whether the received image data is 3D image data based on the detected definition information.

9. The method as claimed in claim 8, wherein the determining, when a vertical definition of the received image data is higher than a vertical definition of two dimensional (2D) image data having a same horizontal definition of the received image data, determines that the received image data is 3D image data.

10. The method as claimed in claim 9, wherein the determining, when the vertical definition of the received image data is higher than the vertical definition of 2D image data having a same horizontal definition of the received image data, determines that the received image data is 3D image data having a frame packing format.

11. The method as claimed in claim 8, further comprising:
when it is determined that the received image data is 3D image data, converting an unsupported format of the 3D image data to a supported 3D format.

12. The method as claimed in claim 11, further comprising:
generating a left eye image frame and a right eye image frame corresponding to the 3D image data having the converted format; and
alternately displaying the left eye image frame and the right eye image.

13. The method as claimed in claim 8, wherein the image data is received over high definition multimedia interface (HDMI).

14. The method as claimed in claim 13, wherein the definition information includes H_total and V_total of an HDMI format.

15. A method for determining a three-dimensional (3D) image, the method comprising:
receiving image data;
detecting definition information from the received image data;
determining, using the definition information, that the received image data is 3D image data when a vertical scanning line of the received image data is higher than a vertical scanning line of two dimensional (2D) image data having a same horizontal scanning line as a horizontal scanning line of the received image data.

16. The method of claim 15, wherein the definition information is a horizontal definition and a vertical definition of image data included in a single frequency.

17. The method of claim 16, wherein when the vertical scanning line of the received image data is higher than the vertical scanning line of the 2D image data which has the same horizontal scanning line of the received image data, the control unit determines that the received image data is 3D image data which has to frame packing format.
